(19) United States
(12) Patent Application Publication
(10) Pub. No.: US 2025/0301175 A1
(43) Pub. Date: Sep. 25, 2025

(54) VALENCE BASED UPDATE FOR VERTICES IN BASE MESH FRAME FOR DYNAMIC MESH CODING

(71) Applicant: Samsung Electronics Co., Ltd., Suwon-si (KR)

(72) Inventors: Rajan Laxman Joshi, San Diego, CA (US); Madhukar Budagavi, Plano, TX (US)

(21) Appl. No.: 19/004,106

(22) Filed: Dec. 27, 2024

Related U.S. Application Data
(60) Provisional application No. 63/568,864, filed on Mar. 22, 2024.
(60) Provisional application No. 63/634,146, filed on Apr. 15, 2024.
(60) Provisional application No. 63/638,151, filed on Apr. 24, 2024.

(51) Int. Cl. H04N 19/63; H04N 19/172; H04N 19/597; H04N 19/61; H04N 19/70

(52) U.S. Cl. CPC H04N 19/63; H04N 19/172; H04N 19/597; H04N 19/61; H04N 19/70

(57) ABSTRACT

An apparatus directed to improvements to update processing for inverse linear lifting transforms is provided. The apparatus receives a compressed bitstream, decodes a base mesh sub-bitstream to reconstruct a base mesh, decodes a displacements sub-bitstream to reconstruct displacement wavelet coefficients, performs an update process with the displacement wavelet coefficients to generate updated displacement wavelet coefficients, performs a prediction process with the updated displacement wavelet coefficients to generate displacements, and reconstructs a mesh frame based on the displacements. During the update process, the apparatus determines a first and second valence indicating a number of connected edges at a first and second vertices which form an edges to which a current vertex belongs, based on whether the first and second vertices belong to the base mesh, and updates a displacement wavelet coefficient of the first and second vertices based on the first and second valence.

### CROSS REFERENCE TO RELATED APPLICATION

This application claims benefit of U.S. Provisional Application No. 63/568,864 filed on Mar. 22, 2024, U.S. Provisional Application No. 63/634,146 filed on Apr. 15, 2024, and U.S. Provisional Application No. 63/638,151 filed on Apr. 24, 2024, in the United States Patent and Trademark Office, the entire contents of which are hereby incorporated by reference.

### TECHNICAL FIELD

The disclosure relates to dynamic mesh coding, and more particularly to, for example, but not limited to, the lifting wavelet transform for displacements.

### BACKGROUND

Currently, International Organization for Standardization (ISO)/International Electrotechnical Commission (IEC) subcommittee 29 working group 07 (ISO/IEC SC29/WG07) is working on developing a standard for video-based compression of dynamic meshes. The seventh test model, V-DMC TMM 7.0, which represents the current status of the standard, was established in the 14th meeting of ISO/IEC SC29 WG07 in January 2024. Draft specification for video-based compression of dynamic meshes is also available.

In accordance with the seventh test model V-DMC TMM 7.0 and the corresponding working draft WD 6.0 (WD 6.0 of V-DMC, ISO/IEC SC29 WG07 N00822, January 2024), the V-DMC encoder produces a number of sub-bitstreams such as atlas, base mesh, displacement and optionally attribute. The V-DMC decoder decodes the displacements bitstream and performs inverse linear lifting transform, which comprises an update process and a prediction process. In the update process, the V-DMC decoder may use an update weight that is derived from the syntax elements included in the V-DMC bitstream. The V-DMC decoder may use a valence-based update weight in the update process which results in BD-rate gains.

However, this method imposes extra computation and memory requirements on the V-DMC decoder. Therefore, there is a need for a simplified method for a valence-based update that retains almost all of the BD-rate gains while substantially reducing the computational and memory requirements.

The description set forth in the background section should not be assumed to be prior art merely because it is set forth in the background section. The background section may describe aspects or embodiments of the present disclosure.

### SUMMARY

This disclosure may be directed to improvements to dynamic mesh coding, more particularly to improvements to the update process of the inverse linear lifting transform in the test model V-DMC TMM 7.0 and the corresponding working draft WD 6.0.

In some embodiments, a simplified method for valence-based update is introduced. This simplified method for valence-based update may retain almost all of the BD-rate gains while substantially reducing the computational and memory requirements by using fixed valence values for new vertices that are produced by subdivision processes.

An aspect of the disclosure provides an apparatus. The apparatus comprises a communication interface and a processor. The communication interface is configured to receive a compressed bitstream including a base mesh sub-bitstream and a displacements sub-bitstream. The processor is operably coupled to the communication interface. The processor is configured to reconstruct a base mesh. The processor is further configured to perform one or more subdivisions of the base mesh to generate a subdivided mesh including a plurality of vertices. The processor is further configured to decode the displacements sub-bitstream to reconstruct displacement wavelet coefficients for the plurality of vertices. The processor is further configured to perform an update process with the displacement wavelet coefficients to generate updated displacement wavelet coefficients for the plurality of vertices. The processor is further configured to perform a prediction process with the updated displacement wavelet coefficients to generate reconstructed displacements. The processor is further configured to reconstruct a mesh frame based on the reconstructed displacements and the subdivided mesh. The processor is further configured to, during the update process, determine a first valence indicating a number of connected edges at a first vertex which forms an edge to which a current vertex belongs, based on whether the first vertex belongs to the base mesh, and update a displacement wavelet coefficient of the first vertex based on the first valence.

In some embodiments, the first valence is determined to be equal to a predetermined value if the vertex does not belong to the base mesh.

In some embodiments, the first valence is determined based on an index of the first vertex from an array of predetermined valences if the first vertex belongs to the base mesh.

In some embodiments, the predetermined value is 6.

In some embodiments, the processor is further configured to, during the update process, determine a second valence indicating a number of connected edges at a second vertex which forms the edge to which the current vertex belongs, based on whether the second vertex belongs to the base mesh. The processor is further configured to update a displacement wavelet coefficient of the second vertex based on the second valence.

In some embodiments, an update weight is determined based on the first syntax element, and the displacement wavelet coefficient of the first vertex is updated based on the first valence and the update weight.

In some embodiments, the compressed bitstream further includes an atlas sub-bitstream including a first syntax element for determining an update weight. The processor is further configured to determine an update weight based on the first syntax element in the bitstream. The displacement wavelet coefficient of the first vertex is updated based on the first valence and the update weight.

In some embodiments, the compressed bitstream further includes an atlas sub-bitstream including a second syntax element for determining a prediction weight. The processor is further configured to determine a prediction weight based on the second syntax element in the bitstream. The displacement of the current vertex is determined based on the prediction weight and the updated displacement wavelet coefficient of the first vertex.

An aspect of the disclosure provides a method. The method comprises receiving a compressed bitstream including a base mesh sub-bitstream and a displacements sub-bitstream. The method further comprises reconstructing a base mesh. The method further comprises performing one or more subdivisions of the base mesh to generate a subdivided mesh including a plurality of vertices. The method further comprises decoding the displacements sub-bitstream to reconstruct displacement wavelet coefficients for the plurality of vertices. The method further comprises performing an update process with the displacement wavelet coefficients to generate updated displacement wavelet coefficients for the plurality of vertices. The method further comprises performing a prediction process with the updated displacement wavelet coefficients to generate reconstructed displacements. The method further comprises reconstructing a mesh frame based on the reconstructed displacements and the subdivided mesh. The method further comprises determining a first valence indicating a number of connected edges at a first vertex which forms an edge to which a current vertex belongs, based on whether the first vertex belongs to the base mesh, and updating a displacement wavelet coefficient of the first vertex based on the first valence.

In some embodiments, the first valence is determined to be equal to a predetermined value if the vertex does not belong to the base mesh.

In some embodiments, the first valence is determined based on an index of the first vertex from an array of predetermined valences if the first vertex belongs to the base mesh.

In some embodiments, the predetermined value is 6.

In some embodiments, the processor is further configured to, during the update process, determine a second valence indicating a number of connected edges at a second vertex which forms the edge to which the current vertex belongs, based on whether the second vertex belongs to the base mesh. The processor is further configured to update a displacement wavelet coefficient of the second vertex based on the second valence.

In some embodiments, the compressed bitstream includes an atlas sub-bitstream including a first syntax element for determining an update weight. The method further comprises determining an update weight based on the first syntax element in the bitstream. The displacement wavelet coefficient of the first vertex is updated based on the first valence and the update weight.

In some embodiments, the compressed bitstream further includes an atlas sub-bitstream including a second syntax element for determining a prediction weight. The method further comprises determining a prediction weight based on the second syntax element in the bitstream. The displacement of the current vertex is determined based on the prediction weight and the updated displacement wavelet coefficient of the first vertex.

An aspect of the disclosure provides an apparatus. The apparatus comprises a communication interface and a processor. The processor is operably coupled to the communication interface. The processor is configured to reconstruct a base mesh, perform one or more subdivisions of the base mesh to generate a subdivided mesh including a plurality of vertices, determine displacements, perform a prediction process with the displacements to generate displacement wavelet coefficients, perform an update process with the displacement wavelet coefficients to generate updated displacement wavelet coefficients, encode the updated displacement wavelet coefficients to generate a compressed displacements bitstream, and transmit a compressed bitstream including the compressed displacements bitstream. The processor is further configured to, during the update process, determine a first valence indicating a number of connected edges at a first vertex which forms an edge to which a current vertex belongs, based on whether the first vertex belongs to the base mesh, and update a displacement wavelet coefficient of the first vertex based on the first valence.

In some embodiments, the first valence is determined to be equal to a predetermined value if the vertex does not belong to the base mesh.

In some embodiments, the first valence is determined based on an index of the first vertex from an array of predetermined valences if the first vertex belongs to the base mesh.

In some embodiments, the predetermined value is 6.

In some embodiments, the processor is further configured to, during the update process, determine a second valence indicating a number of connected edges at a second vertex which forms the edge to which the current vertex belongs, based on whether the second vertex belongs to the base mesh. The processor is further configured to update a displacement wavelet coefficient of the second vertex based on the second valence.

Valence based update results in higher compression efficiency but at the cost of being computationally complex. The simplification in this disclosure retains the benefit of the increased compression efficiency while avoiding the increased computational complexity costs.

### BRIEF DESCRIPTION OF THE DRAWINGS

FIG. 1 illustrates an example communication system 100 in accordance with an embodiment of this disclosure.

FIGS. 2 and 3 illustrate example electronic devices in accordance with an embodiment of this disclosure.

FIG. 4 illustrates a block diagram for an encoder encoding intra frames in accordance with an embodiment.

FIG. 5 illustrates a block diagram for a decoder in accordance with an embodiment.

FIGS. 6 and 7 show the basic block diagrams of a V-DMC encoder and decoder in accordance with an embodiment, respectively.

FIG. 8 shows an example of a resulting reconstructed base mesh from an encoder and decoder in accordance with an embodiment.

FIG. 9 shows an example of the reconstructed base mesh which has undergone one subdivision.

FIG. 10 is a flowchart showing operations of the base mesh encoder in accordance with an embodiment.

FIG. 11 is a flowchart showing operations of the wavelet transformer performing a prediction process.

FIG. 12 is a flowchart showing operations of the wavelet transformer performing an update process.

FIG. 13 is a flowchart showing operations of the base mesh decoder in accordance with an embodiment.

FIG. 14 is a flowchart showing operations of the inverse wavelet transformer performing an update process.

FIG. 15 is a flowchart showing operations of the inverse wavelet transformer performing a prediction process.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

Three hundred sixty degree (360°) video and 3D volumetric video are emerging as new ways of experiencing immersive content due to the ready availability of powerful handheld devices such as smartphones. While 360° video enables immersive “real life,” “being there” experience for consumers by capturing the 360° outside-in view of the world, 3D volumetric video can provide complete 6DoF experience of being and moving within the content. Users can interactively change their viewpoint and dynamically view any part of the captured scene or object they desire. Display and navigation sensors can track head movement of the user in real-time to determine the region of the 360° video or volumetric content that the user wants to view or interact with. Multimedia data that is three-dimensional (3D) in nature, such as point clouds or 3D polygonal meshes, can be used in the immersive environment.

A point cloud is a set of 3D points along with attributes such as color, normal, reflectivity, point-size, etc. that represent an object's surface or volume. Point clouds are common in a variety of applications such as gaming, 3D maps, visualizations, medical applications, augmented reality, virtual reality, autonomous driving, multi-view replay, 6DoF immersive media, to name a few. Point clouds, if uncompressed, generally require a large amount of bandwidth for transmission. Due to the large bitrate requirement, point clouds are often compressed prior to transmission. To compress a 3D object such as a point cloud, often requires specialized hardware. To avoid specialized hardware to compress a 3D point cloud, a 3D point cloud can be transformed into traditional two-dimensional (2D) frames and that can be compressed and later be reconstructed and viewable to a user.

Polygonal 3D meshes, especially triangular meshes, are another popular format for representing 3D objects. Meshes typically consist of a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively.

Since point clouds and meshes contain a large amount of data, they require compression for efficient storage and transmission. This is particularly true for dynamic point clouds and meshes, which may contain 60 frames or higher per second.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

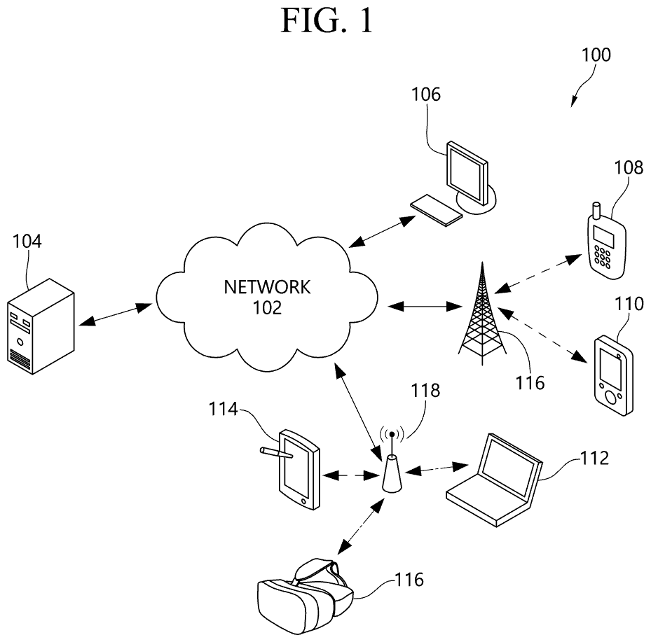

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (cNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can then compress 3D point cloud or mesh to generate a bitstream and then transmit the bitstream to one or more of the client devices 106-116. For another example, one of the client devices 106-116 can compress a 3D point cloud or mesh to generate a bitstream and then transmit the bitstream to another one of the client devices 106-116 or to the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

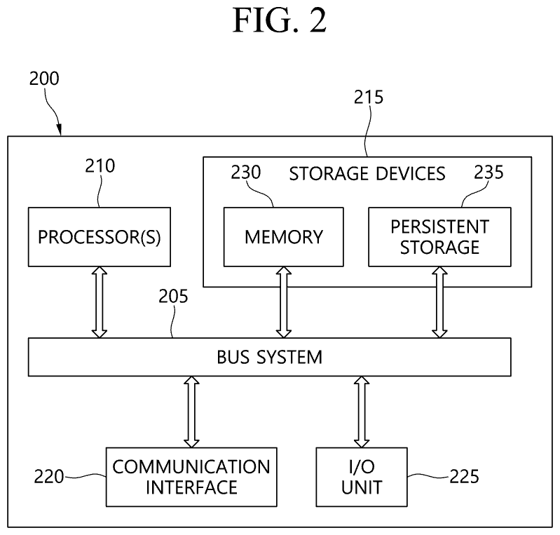

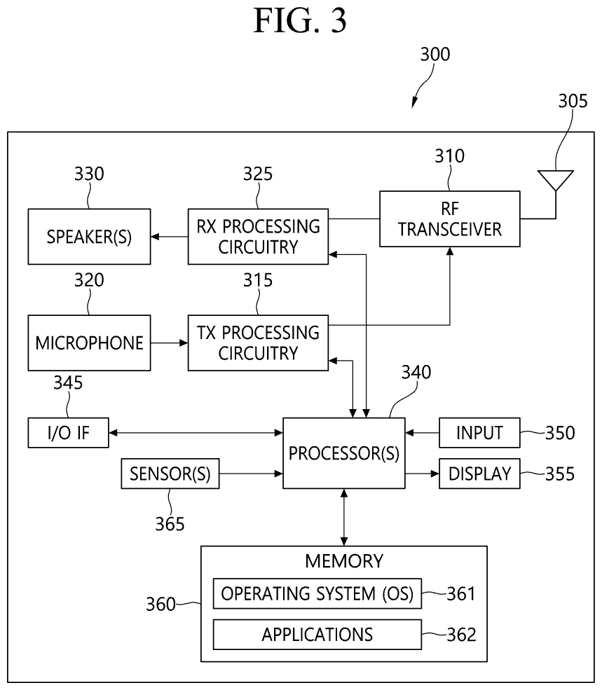

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

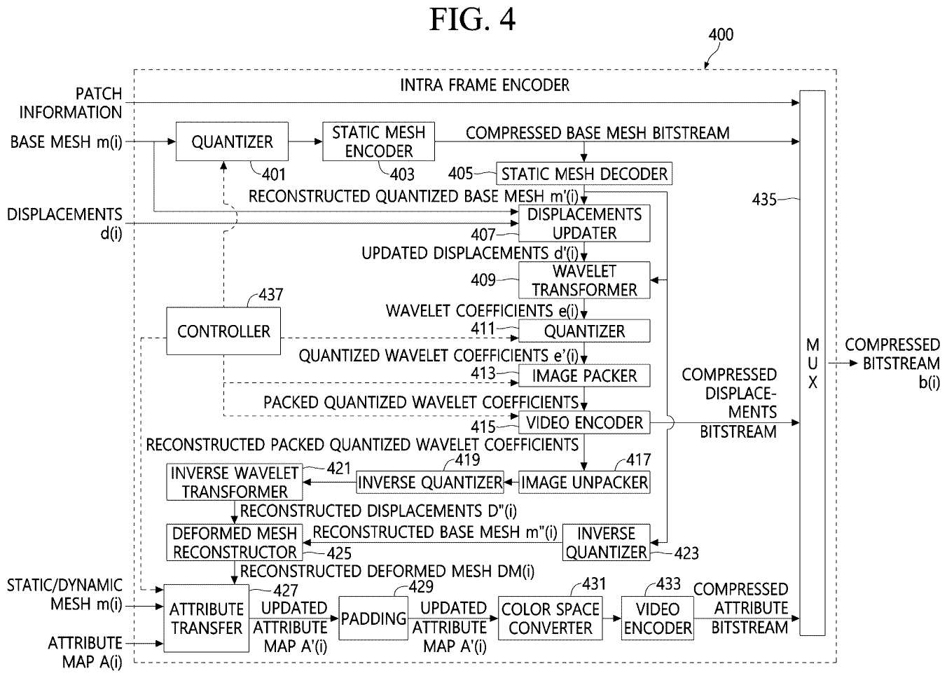

FIG. 4 illustrates a block diagram for an encoder encoding intra frames in accordance with an embodiment.

As shown in FIG. 4, the encoder 400 encoding intra frames in accordance with an embodiment may comprise a quantizer 401, a static mesh encoder 403, a static mesh decoder 405, a displacements updater 407, a wavelet transformer 409, a quantizer 411, an image packer 413, a video encoder 415, an image unpacker 417, an inverse quantizer 419, an inverse wavelet transformer 421, an inverse quantizer 423, a deformed mesh reconstructor 425, an attribute transfer module 427, a padding module 429, a color space converter 431, a video encoder 433, a multiplexer 435, and a controller 437.

The quantizer 401 may quantize a base mesh m(i) to generate a quantized base mesh. In some embodiments, the base mesh may have fewer vertices compared to an original mesh.

The static mesh encoder 403 may encode and compress the quantized base mesh to generate a compressed base mesh bitstream. In some embodiments, the base mesh may be compressed in a lossy or lossless manner. In some embodiments, an already existing mesh codec such as Draco may be used to compress the base mesh.

The static mesh decoder 405 may decode the compressed base mesh bitstream to generate a reconstructed quantized base mesh m′(i).

The displacements updater 407 may update displacements d(i) based on the base mesh m(i) after subdivision and the reconstructed quantized base mesh m′(i) to generate updated displacements d′(i). The reconstructed base mesh may undergo subdivision and then a field between the original mesh and the subdivided reconstructed base mesh may be determined. In inter coding of mesh frame, the base mesh may be coded by sending vertex motions instead of compressing the base mesh directly. In either case, a displacement field may be created. The displacement field as well as the modified attribute map may be coded using a video codec and also included as a part of the V-DMC bitstream.

The wavelet transformer 409 may perform a wavelet transform with the updated displacements d′(i) to generate displacement wavelet coefficients e(i). The wavelet transform may comprise a series of prediction and update lifting processes.

The quantizer 411 may quantize the displacement wavelet coefficients e(i) to generate quantized displacement wavelet coefficients e′(i). The quantized displacement wavelet coefficients may be denoted by an array dispQuantCoeffArray.

The image packer 413 may pack the quantized displacement wavelet coefficients e′(i) into a 2D image including packed quantized displacement wavelet coefficients dispQuantCoeffFrame. The 2D video frame may be referred to as a displacement frame or a displacement video frame in this disclosure.

The video encoder 415 may encode the packed quantized displacement wavelet coefficients dispQuantCoeffFrame to generate a compressed displacements bitstream.

The image unpacker 417 may unpack the packed quantized displacement wavelet coefficients dispQuantCoeffFrame to generate an array dispQuantCoeffArray of quantized displacement wavelet coefficients.

The inverse quantizer 419 may inversely quantize the array dispQuantCoeffArray of quantized displacement wavelet coefficients to generate displacement wavelet coefficients.

The inverse wavelet transformer 421 may perform an inverse wavelet transform with the displacement wavelet coefficients to generate reconstructed displacements d″(i).

The inverse quantizer 423 may inversely quantize the reconstructed quantized base mesh m′(i) to generate a reconstructed base mesh m″(i).

The deformed mesh reconstructor 425 may generate a reconstruct deformed mesh DM(i) based on the reconstructed displacements D″(i) and a reconstructed base mesh m″(i).

The attribute transfer module 427 may update an attribute map A(i) based on a static/dynamic mesh m(i) and a reconstructed deformed mesh DM(i) to generate an updated attribute map A′(i). The attribute map may be a texture map but other attributes may be sent as well.

The padding module 429 may perform padding to fill empty areas in the updated attribute map A′(i) so as to remove high frequency components.

The color space converter 431 may perform a color space conversion of the padded updated attribute map A′(i).

The video encoder 433 may encode the output of the color space converter 431 to generate the compressed attribute bitstream.

The multiplexer 435 may multiplex the compressed base mesh bitstream, the compressed displacements bitstream, and the compressed attribute bitstream to generate a compressed bitstream b(i).

The controller 437 may control modules of the encoder 400.

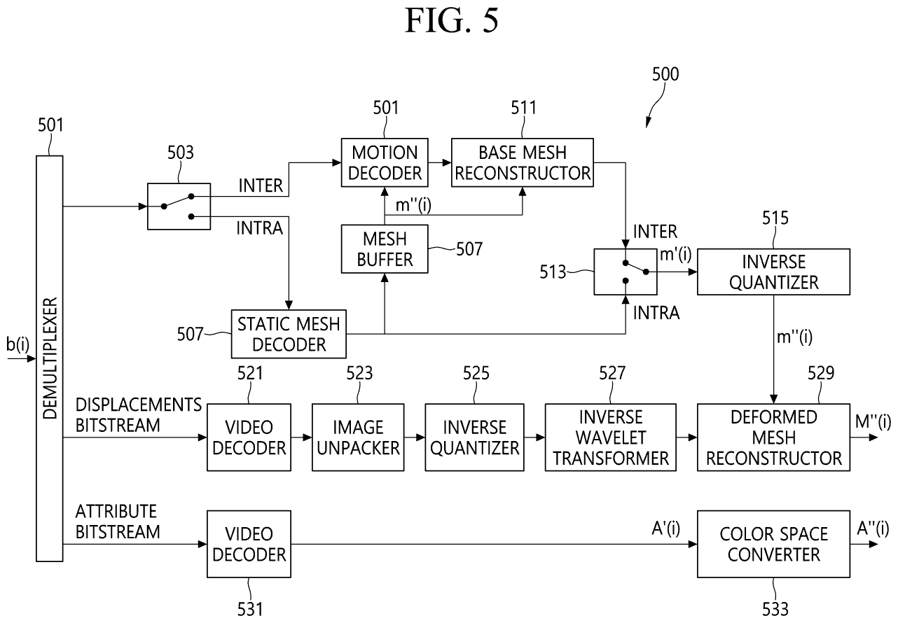

FIG. 5 illustrates a block diagram for a decoder in accordance with an embodiment.

As shown in FIG. 5, the decoder 500 may comprise a demultiplexer 501, a switch 503, a static mesh decoder 505, a mesh buffer 507, a motion decoder 509, a base mesh reconstructor 511, a switch 513, an inverse quantizer 515, a video decoder 521, an image unpacker 523, an inverse quantizer 525, an inverse wavelet transformer 527, a deformed mesh reconstructor 529, a video decoder 531, and a color space converter 533.

The demultiplexer 501 may receive the compressed bitstream b(i) from the encoder 400 to extract the compressed base mesh bitstream, the compressed displacements bitstream, and the compressed attribute bitstream from the compressed bitstream b(i).

The switch 503 may determine whether the compressed base mesh bitstream has an inter-coded mesh frame or an intra-coded mesh frame. If the compressed base mesh bitstream has the inter-coded mesh frame, the switch 503 may transfer the inter-coded mesh frame to the motion decoder 509. If the compressed base mesh bitstream has the intra-coded mesh frame, the switch 503 may transfer the intra-coded mesh frame to the static mesh decoder 505.

The static mesh decoder 505 may decode the intra-coded mesh frame to generate a reconstructed quantized base mesh frame.

The mesh buffer 507 may store the reconstructed quantized base mesh frames and the inter-coded mesh frame for future use of decoding subsequent inter-coded mesh frames. The reconstructed quantized base mesh frames may be used as reference mesh frames.

The motion decoder 509 may obtain motion vectors for a current inter-coded mesh frame based on data stored in the mesh buffer 507 and syntax elements in the bitstream for the current inter-coded mesh frame. In some embodiments, the syntax elements in the bitstream for the current inter-coded mesh frame may be a motion vector difference.

The base mesh reconstructor 511 may generate a reconstructed quantized base mesh frame by using syntax elements in the bitstream for the current inter-coded mesh frame based on the motion vectors for the current inter-coded mesh frame.

The switch 513 may transmit the reconstructed quantized base mesh frame from the static mesh decoder 505 to the inverse quantizer 515, if the compressed base mesh bitstream has the intra-coded mesh frame. The switch 513 may transmit the reconstructed quantized base mesh frame from the static mesh decoder 511 to the inverse quantizer 515, if the compressed base mesh bitstream has the inter-coded mesh frame.

The inverse quantizer 515 may perform an inverse quantization with the reconstructed quantized base mesh frame to generate a reconstructed base mesh frame m″(i).

The video decoder 521 may decode a displacements bitstream to generate packed quantized displacement wavelet coefficients dispQuantCoeffFrame.

The image unpacker 523 may unpack the packed quantized displacement wavelet coefficients dispQuantCoeffFrame to generate an array dispQuantCoeffArray of quantized displacement wavelet coefficients.

The inverse quantizer 525 may perform the inverse quantization with the array dispQuantCoeffArray of quantized displacement wavelet coefficients to generate displacement wavelet coefficients.

The inverse wavelet transformer 527 may perform the inverse wavelet transform with displacement wavelet coefficients to generate displacements.

The deformed mesh reconstructor 529 may reconstruct a deformed mesh based on the displacements and the reconstructed base mesh frame m″(i).

The video decoder 531 may decode the attribute bitstream to generate an attribute map before a color space conversion.

The color space converter 533 may perform a color space conversion of the attribute map from the video decoder 531 to reconstruct the attribute map.

The following documents are hereby incorporated by reference in their entirety into the present disclosure as if fully set forth herein: i) V-DMC TMM 7.0, ISO/IEC SC29 WG07 N00811, January 2024, ii) “WD 6.0 of V-DMC”, ISO/IEC SC29 WG07 N00822, January 2024, iii) “Text of ISO/IEC DIS 23090-29 Video-based mesh coding”, ISO/IEC SC29 WG07 N01027, December 2024 and iv) “[V-DMC] [EE4.7—Test 7.1] Valence-based adaptive lifting update”, ISO/IEC JTC 1/SC 29/WG 7 m66331 (m66331), January 2024.

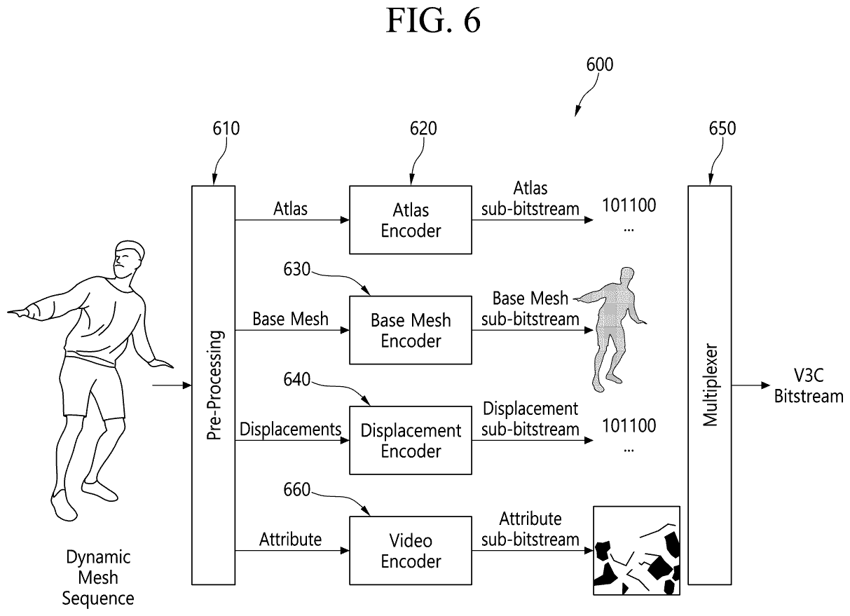

FIG. 6 shows a basic block diagram for V-DMC encoder in accordance with an embodiment.

Referring to FIG. 6, the V-DMC encoder 600 in accordance with an embodiment includes pre-processing unit 610, an atlas encoder 620, a base mesh encoder 630, a displacement encoder 640, and a multiplexer 650. In some embodiments, the V-DMC encoder 600 may include a video encoder 660.

The pre-processing unit 610 may process the dynamic mesh sequence to generate atlas information, base mesh m(i), and displacement d(i). In some embodiments, the pre-processing unit 610 may further process the dynamic mesh sequence to additionally generate attribute A(i). The atlas encoder 620 may encode the atlas information to generate an atlas sub-bitstream. The base mesh encoder 630 may encode the base mesh m(i) to generate a base mesh sub-bitstream. The displacement encoder 640 may encode the displacement d(i) to generate a displacements sub-bitstream. In some embodiments, the video encoder 660 may encode the attribute A(i) to generate an attribute sub-bitstream. The multiplexer 650 may combine the atlas sub-bitstream, base mesh sub-bitstream and the displacements sub-bitstream to generate a single V3C Bitstream b(i). In some embodiments, the multiplexer 650 may combine the atlas sub-bitstream, base mesh sub-bitstream, the displacements sub-bitstream and the attribute sub-bitstream to generate a single V3C Bitstream b(i). Thus, for each mesh frame, the V-DMC encoder creates a base mesh, which typically has a lesser number of vertices compared to the original mesh. The base mesh is compressed either in a lossy or lossless manner to create a base mesh sub-stream. The V-DMC encoder also generates the reconstructed base mesh.

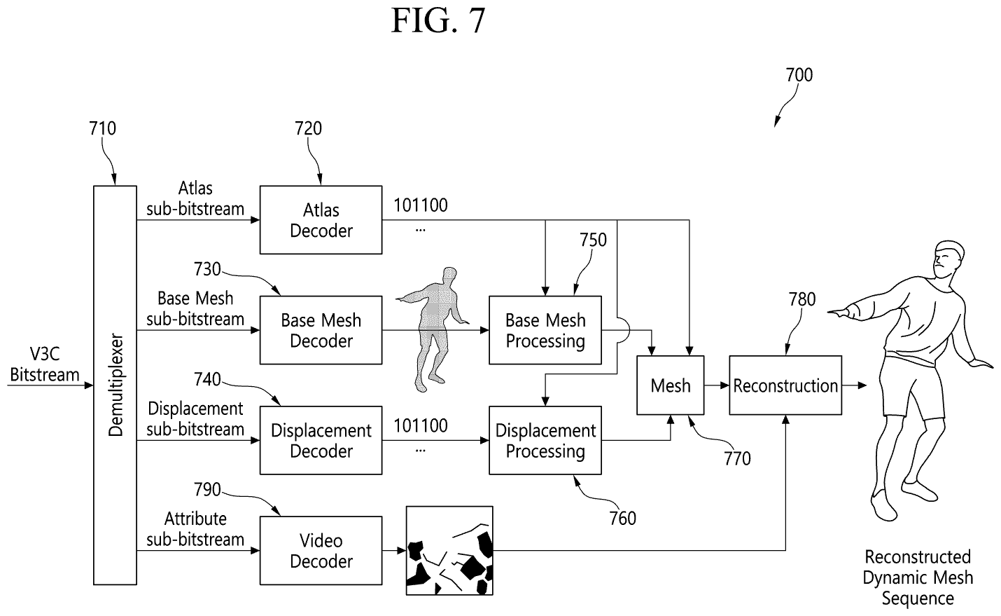

FIG. 7 shows a basic block diagram for a V-DMC decoder in accordance with an embodiment.

Referring to FIG. 7, the V-DMC decoder 700 in accordance with an embodiment includes a demultiplexer 710, an atlas decoder 720, a base mesh decoder 730, a displacement decoder 740, a base mesh processing unit 750, a displacement processing unit 760, a mesh processing unit 770 and a reconstruction processing unit 780. In some embodiments, the V-DMC decoder 700 may include a video decoder 790.

The demultiplexer 710 may separate the V3C Bitstream b(i) to generate the atlas sub-bitstream, the base mesh sub-bitstream, and the displacements sub-bitstream. In some embodiments, the demultiplexer 710 may further separate the V3C Bitstream b(i) to additionally generate the attribute sub-bitstream. The atlas decoder 720 may decode the atlas sub-bitstream to generate the atlas information. The base mesh decoder 730 may decode the base mesh sub-bitstream to generate the base mesh m(i). The displacement decoder 740 may decode the displacements sub-bitstream to generate the displacement d(i). In some embodiments, the video decoder 790 may decode the attribute sub-bitstream to generate the attribute A(i). The base mesh processor 750 may process the atlas information and the base mesh m(i) to generate a reconstructed base mesh m″(i). The displacement processor 760 may process the atlas information and the displacement d(i) to generate a reconstructed displacements. The mesh processor 770 may process the atlas information, the reconstructed base mesh m″(i) and the reconstructed displacement matrix D″(i) to generate the reconstructed deformed mesh DM(i). In, some embodiments, the reconstruction processing unit 780 may process the reconstructed deformed mesh DM(i) and the attribute A(i) to generate the reconstructed dynamic mesh sequence.

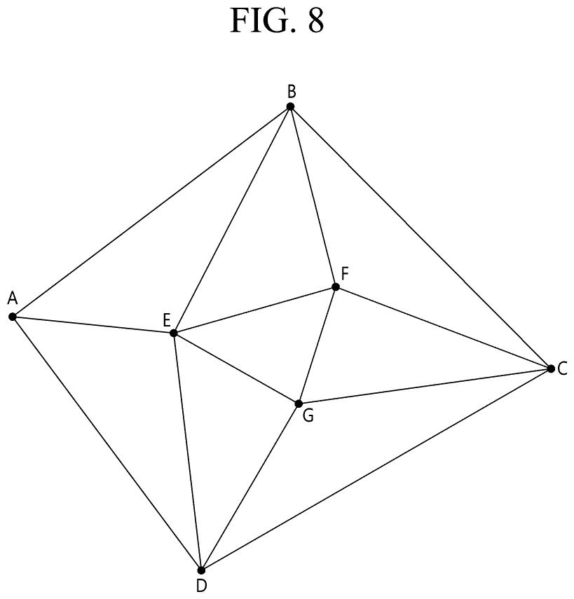

FIG. 8 shows an example of a resulting reconstructed base mesh from an encoder and decoder in accordance with an embodiment. There are 7 vertices (A, B, . . . , G) in this mesh. The edges AB, BC, CD, and DA may be considered as the boundary of the mesh. The rest of the edges may be considered non-boundary or interior edges. Typically, the boundary edges belong to only a single triangle, whereas the interior edges belong to multiple triangles.

The reconstructed base mesh may undergo one or more subdivisions. In the case of V-DMC, subdivision method, such as midpoint subdivision, loop subdivision, normal subdivision and Pythagorean means based subdivision, is used where for every edge in the current mesh an additional vertex is introduced. For midpoint subdivision, the additional vertex is introduced at the midpoint of the edge. For loop subdivision, the additional vertex is introduced as determined using a weighted average of the positions that form the edge. For normal subdivision, the additional vertex is introduced based on the generation of normal vectors to introduce the new edges. For Pythagorean means subdivision, the additional vertex is introduced as determined based on the average, the harmonic average or the geometric average of the positions that form an edge. For each triangle from the current mesh, new edges are introduced to connect the three newly introduced vertices to each other. Thus, each triangle is subdivided into 4 triangles.

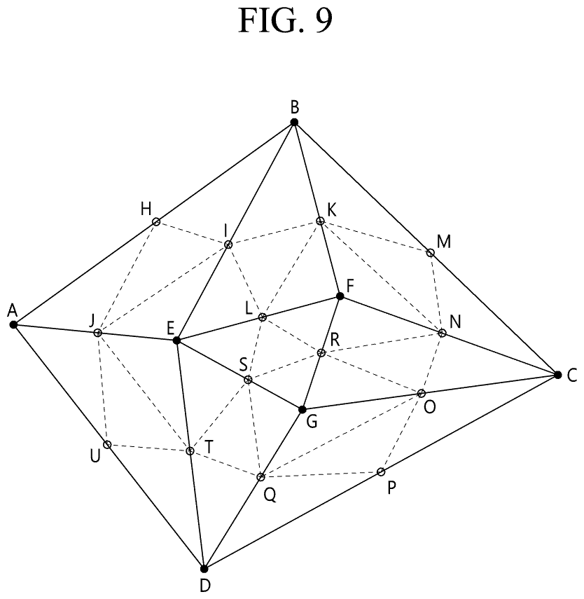

FIG. 9 shows an example of the reconstructed base mesh which has undergone one subdivision. Referring to FIG. 9, This subdivision introduces 14 new vertices (H, I, . . . , U). This process may be continued for additional subdivisions. The total number of subdivisions may be denoted by subdivisionIterationCount. The number of vertices introduced by the k-th subdivision may be denoted by levelOfDetailVertexCounts[k], k=0, 1, . . . , (subdivisionIterationCount+1), where levelOfDetailVertexCounts[0] indicates the number of vertices in the reconstructed base mesh. Each subdivision may also be referred to as level-of-detail.

The total number N of vertices in the subdivided mesh may be expressed as shown in the following Equation 1:

$$N = {\sum }_{k = 0}^{subdivision Iteration Count} levelOfDetailVertexCounts [ k ] . \qquad Equation 1$$

For each vertex in the subdivided mesh, the V-DMC encoder determines a displacement vector with respect to the original mesh surface. Each displacement vector has 3 components, denoted by x, y, and z. These may be with respect to a canonical coordinate system or a local coordinate system where the x, y, and z represent in local normal, tangent, and bi-tangent directions. The 3-D displacement vectors may be expressed as shown in the following Equation 2:

$$d ( i ) = [ {d}_{x} ( i ) , {d}_{y} ( i ) , {d}_{z} ( i ) ] , 0 \leq i < N . \qquad Equation 2$$

On the encoder side, as implemented in the test model V-DMC TMM 7.0, the 3-D displacement vectors undergo forward linear lifting transform. The lifting transform process starts with the highest subdivision level and continues up to the first subdivision level. At each subdivision level, for each vertex, prediction and update processes are performed. The vertex is expressed as v and vertices which form the edge to which the vertex v belongs be denoted by v₁ and v₂. Then, the prediction process may be expressed as shown in Equation 3:

$$d ( v ) ← d ( v ) - predWeight * ( d ( {v}_{1} ) + d ( {v}_{2} ) ) . \qquad Equation 3$$

After the prediction process, the V-DMC encoder may update the displacements corresponding to the vertices v₁ and v₂ as expressed in Equation 4 and Equation 5:

$$\begin{matrix}d ( {v}_{1} ) ← d ( {v}_{1} ) + updateWeight * d ( v ) . & Equation 4 \\ d ( {v}_{2} ) ← d ( {v}_{2} ) + updateWeight * d ( v ) . & Equation 5\end{matrix}$$

In some embodiments, the prediction weight predWeight and the update weight updateWeight may be a function of the subdivision level and index of the subdivision to which the vertex v belongs. In some embodiments, the V-DMC encoder and V-DMC decoder may determine the prediction weight predWeight and the update weight updateWeight based on the subdivision level and index of the subdivision to which the vertex v belongs.

In some embodiments, after forward linear lifting transform, the resulting transformed displacement field may be quantized. The quantized transform displacement field may be packed into a video frame and then compressed using a video codec.

In some embodiments, the quantized transformed displacement field may be directly entropy-coded using arithmetic coding.

As specified in WD 6.0 of V-DMC and implemented in Test Model V-DMC TMM 7.0, the V-DMC decoder may reconstruct a quantized transformed displacement field either by decoding the packed, compressed video or by arithmetic decoding. Then, the reconstructed transformed displacement field undergoes inverse lifting wavelet transform. The lifting process starts with the first subdivision level and continues up to the highest subdivision level. At each subdivision level, for each of the vertices belonging to that level, update and prediction processes are performed. The update process may be expressed in Equations 6 and 7:

$$\begin{matrix}d ( {v}_{1} ) ← d ( {v}_{1} ) - updateWeight * d ( v ) . & Equation 6 \\ d ( {v}_{2} ) ← d ( {v}_{2} ) - updateWeight * d ( v ) . & Equation 7\end{matrix}$$

After the update process, the prediction process is performed. The prediction process may be expressed in Equation 8:

$$d ( v ) ← d ( v ) + predWeight * ( d ( {v}_{1} ) + d ( {v}_{2} ) ) . \qquad Equation 8$$

The compressed V-DMC bitstream includes the syntax elements related to update and prediction, which allow the V-DMC decoder to derive updateWeight and predWeight. The encoder and decoder typically use the update weights.

The update weight may be made dependent on the valence of the corresponding vertex, as was proposed in “[V-DMC] [EE4.7—Test 7.1] Valence-based adaptive lifting update”, ISO/IEC JTC 1/SC 29/WG 7 m66331 (m66331). On the encoder side, the update process may be modified as expressed in Equations 9 and 10:

$$\begin{matrix}d ( {v}_{1} ) ← d ( {v}_{1} ) + \frac{1.0}{valence ( {v}_{1} )} * K * d ( v ) . & Equation 9 \\ d ( {v}_{2} ) ← d ( {v}_{2} ) + \frac{1.0}{valence ( {v}_{2} )} * K * d ( v ) . & Equation 10\end{matrix}$$

And on the decoder side, the update process may be modified as expressed in Equations 11 and 12:

$$\begin{matrix}d ( {v}_{1} ) ← d ( {v}_{1} ) - \frac{1.0}{valence ( {v}_{1} )} * K * d ( v ) . & Equation 11 \\ d ( {v}_{2} ) ← d ( {v}_{2} ) - \frac{1.0}{valence ( {v}_{2} )} * K * d ( v ) . & Equation 12\end{matrix}$$

Here K may be a constant that depends on the subdivision level as well as syntax elements related to update weights signaled in the V-DMC bitstream.

The valence of a vertex v may represent the number of other vertices that it is directly connected to. Alternatively, the valence of a vertex v may be considered as the number of edges that begin or end in the vertex v.

This method was shown to have produced BD-rate gains in the range of 0.5% to 0.7% compared with TMM 6.0 anchor under common test conditions. However, to implement this method, it is necessary to determine the valences of v₁ and v₂ on the fly. These can be computationally complex operations needing a lot of memory accesses. Alternatively, the valences for vertices in subdivision levels from 0 to (subdivisionIterationCount−1) may be precomputed and stored in memory. However, depending on the number of vertices in the base mesh and subdivisionIterationCount, the amount of memory required may be prohibitive.

To overcome this drawback a simplification may be used that reduces the memory and/or computational requirement while retaining almost all of the gain of using the valence in the update process.

FIG. 9 shows an example of the reconstructed base mesh which has undergone one subdivision.

Referring to FIG. 9, each new vertex, which is produced by midpoint subdivision, has a valence of 6. The only exception is when a new vertex subdivides an edge that belongs to the boundary of the base mesh. In that case, the valence for the new vertex is 4. In some embodiments, a modified valence function, valenceMod may be used. The function valenceMod may be expressed as in Equation 13:

$$valenceMod ( v ) = \{ \begin{matrix}valence ( v ) , & \begin{matrix}if vertex v belongs to the \\ reconstructed base mesh\end{matrix} \\ 6 , & otherwise\end{matrix} . \qquad Equation 13$$

In an embodiment which uses valenceMod, the valences may need to be determined and stored only for the vertices belonging to the base mesh, thereby saving significant amount of computation and memory.

In some embodiments, the update processes in the inverse lifting wavelet transform may be modified as expressed in Equations 14 and 15:

$$\begin{matrix}d ( {v}_{1} ) ← d ( {v}_{1} ) - \frac{1.0}{valence Mod ( {v}_{1} )} * K * d ( v ) . & Equation 14 \\ d ( {v}_{2} ) ← d ( {v}_{2} ) - \frac{1.0}{valenceMod ( {v}_{2} )} * K * d ( v ) . & Equation 15\end{matrix}$$

In some embodiments, in addition to modifying the update process in the inverse lifting wavelet transform, the update process in the forward lifting wavelet transform is also modified as expressed in Equations 16 and 17:

$$\begin{matrix}d ( {v}_{1} ) ← d ( {v}_{1} ) + \frac{1.0}{valence Mod ( {v}_{1} )} * K * d ( v ) . & Equation 16 \\ d ( {v}_{2} ) ← d ( {v}_{2} ) + \frac{1.0}{valenceMod ( {v}_{2} )} * K * d ( v ) . & Equation 17\end{matrix}$$

When a new vertex divides an edge that belongs to the boundary of the base mesh, its valence is 4. In some embodiments, valenceMod may be determined as shown the Equation 18:

$$valenceMod ( v ) = \{ \begin{matrix}valence ( v ) , & \begin{matrix}if vertex v belongs to the \\ reconstructed base mesh\end{matrix} \\ 4 , & \begin{matrix}if vertex v lies on the \\ boundary of the base mesh\end{matrix} \\ 6 , & otherwise\end{matrix} . \qquad Equation 18$$

In some embodiments, Equation 18 may be used in the update process of the inverse lifting wavelet transform.

In some embodiments, Equation 18 may be used to modify the update processes in both the forward and the inverse lifting wavelet transforms.

In some embodiments, a fixed value M may be used in the calculation of valenceMod. The value of M can be fixed for all levels of detail (LODs) or can be fixed per level of detail (LOD). The function of valenceMod may be expressed as shown in Equation 19:

$$valenceMod ( v ) = \{ \begin{matrix}valence ( v ) , & \begin{matrix}if vertex v belongs to the \\ reconstructed base mesh\end{matrix} \\ M , & otherwise\end{matrix} . \qquad Equation 19$$

In some embodiments, Equation 19 may be used in the update process in the inverse lifting wavelet transform.

In some embodiments, Equation 19 may be used in the update processes in both the forward and the inverse lifting wavelet transforms.

Referring to the reconstructed base mesh in FIG. 8 and the subdivided reconstructed base mesh in FIG. 9, the valence of the vertices that are present in the reconstructed base mesh does not change when subdivision is performed.

In some embodiments, the valence of the vertices corresponding to the reconstructed base mesh may be determined based on the reconstructed base mesh before any subdivision is performed.

In some embodiments, the valence of the vertices corresponding to the reconstructed base mesh may be obtained as an output of the base mesh decoder and does not need to be redetermined.

In some embodiments, one syntax element may be included in the bitstream and may be signaled in an atlas sequence parameter set V-DMC extension asps_vdmc_extension. The syntax element may take values of 0, 1, or 2. If the value of the syntax element is 0, the update process is as described in WD 6.0 of V-DMC. If the value of the syntax element value is 1, the update process is based on the valence as described in m66331. If the value of the syntax element value is 2, the valence-based update process with simplification as described in one of the above embodiments is used.

In some embodiments, two flags may be included in the bitstream and may be signaled in an atlas sequence parameter set V-DMC extension asps_vdmc_extension. The first flag indicates whether valence-based update is used. A value of 0 for the first flag indicates that the update process as described in WD 6.0 of V-DMC is used. A value of 1 for the first flag indicates that a valence-based update process may be used. If the value of the first flag is 1, a second flag is signaled to indicate whether valence-based update with simplification as described in one of the above embodiments may be used. A value of 0 for the second flag indicates that the update process as described in m66331 may be used. A value of 1 for the second flag indicates that the valence-based update with simplification as described in on the above embodiments may be used.

In some embodiments, one flag may be included in the bitstream and may be signaled in an atlas sequence parameter set V-DMC extension asps_vdmc_extension. The flag indicates whether valence-based update with simplification as described none of the above embodiments may be used. A value of 0 for the flag indicates that the update process as described in WD 6.0 of V-DMC may be used. A value of 1 for the flag indicates that the valence based update process with simplification described in one of the above embodiments may be used.

In some embodiments, clause 11 in the text specification of WD6.0 of V-DMC is modified, clause 11 is modified as shown in Tables 1-6 below.

TABLE 1
11.2.3 Subdivision Process
11.2.3.1 General
...[Same as in WD6.0 of V-DMC]
11.2.3.2 Midpoint subdivision process
Inputs to this process are:

| | |
|---|---|
| - | positionDimension, indicating the dimension of the positions to be subdivided, |
| - | subdivisionCount, indicating the number of subdivision iterations to be applied, |
| - | positionCountIn, indicating the number of positions to be subdivided, |
| - | faceCountIn, indicating the number of faces created with the positions, |
| - | positionArrayIn, of size positionCountIn x positionDimension indicating the positions |
| | to be subdivided, |

The outputs to the process are:

| | |
|---|---|
| - | positionCountOut, indicating the number of positions, |
| - | faceCountOut, indicating the number of faces, |
| - | positionArrayOut, of size positionCountOut x positionDimension, indicating the |
| | positions, |
| - | facesArrayOut, of size faceCount x 3, indicating the connectivity indices associated with |
| | the positions |
| - | edges, of size positionCountOut x 2, indicating the indices of two positions used to |
| | generate the position of the current index, |
| - | levelofDetailCounts, of size (subdivisionCount + 1), indicating the number of positions |
| | associated with each subdivision iteration. |
| - | valences, of size (positionCountIn), indicating the number of connected edges at each |
| | vertex. |

In Table 1, the inputs to the midpoint subdivision process are changed to contain the above listed inputs and outputs.

```
TABLE 2
First, 2D array edges is determined as follows:
for ( a = 0; a < positionCountIn; a++) {
  neighbourCounts[ a ] = 0
}
positionCounter = positionCountIn
faceCounter = faceCountIn
ComputeNeighbours( faceCount, faces, neighbours, neighbourCounts)
for( a = 0; a < positionCount; a++ ) {
  valences[ a ] = neighbourCounts[ a ]
  for( n = 0; n < neighbourCounts[ a ]; n++ ) {
    b = neighbours [ a ][ n ]
    if ( a > b ) {
      edges[ positionCounter ][ 0 ] = a
      edges[ positionCounter ][ 1 ] = b
      edgeToPosition [ a ][ b ] = positionCounter
      positionCounter += 1
    }
  }
}
...[same as in WD6.0 of V-DMC]
```

In Table 2, the array of 2D edges is determined by first setting all values in the array neighborCounts to 0. Next, the function ComputeNeighbors is used to determine the values of the array neighborCounts. For every position to be subdivided, a first position is determined to be the current position. For every neighbor of that first position, the second position is determined to be a neighbor of the first position and if the second position is a position which a new edge can be created (i.e., is not a newly subdivided position) then the edges array at the current index (positionCounter) is determined to be the edge created by the first position and the second position.

TABLE 3
11.2.6 Inverse transform
11.2.6.1 General
...[same as in WD6.0 of V-DMC]
If transformMethod is equal to LINEAR_LIFTING, then process described in subclause
11.2.6.2 is invoked with the parameters variables verCoordCount, dispCoeffArray,
sudivisionIterationCount, levelOfDetailCounts, edges, valenceUpdate and valences as inputs,
dispArray as outputs
Otherwise, if transformMethod is equal to NONE, the output 2D array dispArray is derived as
follows:
dispArray = dispCoeffArray
11.2.6.2 Inverse linear lifting transform
Inputs to this process are:

| | |
|---|---|
| - | verdCoordCount, which is a variable indicating the number of vertex coordinates in the |
| | subdivided submesh. |
| - | dispCoeffArray, which is a 2D array of size verCoordCount x 3 indicating the |
| | displacement wavelet coefficients. |
| - | subdivisionIterationCount, which is a variable indicating the number of subdivision |
| | iterations. |
| - | levelOfDetailCounts, a 1D array of size (subdivisionIterationCount + 1) indicating the |
| | number of vertex coordinates associated with each subdivision iteration. |
| - | edges, which is a 2D array of size verCoordCount x 2 which indicates for each vertex v |
| | produced by the subdivision process described in subclause 11.2.3 the two indices (a, b) |
| | of the two vertices used to generate it (i.e., v generated as the middle of the edge (a, b)). |
| - | valenceUpdate, which is a variable indicating whether the update operation use valence- |
| | based weight (when 1) or not (when 0). |
| - | valences, which is a 1D array of size levelOfDetailCounts[0], indicating the number of |
| | connected edges at each vertex of the submesh before any subdivisions are applied |

The ouput of this process is:

| | |
|---|---|
| - | a 2D array dispArray, of size verCoordCount x 3, indicating the displacements to be |
| | applied to the mesh position. |

In Table 3, the inputs to the inverse transform process are changed to contain the above listed inputs and outputs.

TABLE 4

```
First, variables are derived as follows:
for ( i = 0; i < subdivisionIterationCount; i++) {
  updateWeights[i] = UpdateWeight[ LtpIndex ][ i ]
  predWeights[ i ] = PredictionWeight[ LtpIndex ][ i ]
}
skipUpdate = vltp_skip_update_flag[ 0 ][ LtpIndex ]
```

In Table 4, the update Weights and the predWeights are determined from values derived from syntax present in the compressed bitstream.

TABLE 5

```
The inverse wavelet transform process proceeds as follows:
for ( i = 0; i < subdivisionIterationCount; i++ ) {
  vcount0 = levelOfDetailVertexCounts[ i ]
  vcount1 = levelOfDetailVertexCounts[ i + 1 ]
  for ( v = vcount0; skipUpdate == 0 && v < vcount1; ++v ) {
    a = verCoordEdges[ v ][ 0 ]
    b = verCoordEdges[ v ][ 1 ]
    for (d = 0; d < DisplacementDim; d++) {
        if (valenceUpdate) {
          valenceA = ( a < levelOfDetailVertexCounts[0]))
          ? valences[a] : 6
          valenceB = ( b < levelOfDetailVertexCounts[0]))
          ? valences[b] : 6
          disp0 = updateWeights[ i ] *
          dispCoeffArray[ v ][ d ] / valenceA
          disp1 = updateWeights[ i ] *
          dispCoeffArray[ v ][ d ] / valenceB
          dispCoeffArray[ a ][ d ] −= disp0
          dispCoeffArray[ b ][ d ] −= disp1
        }
        else {
            disp = updateWeights[ i ] * dispCoeffArray[ v ][ d ]
              dispCoeffArray[ a ][ d ] −= disp
              dispCoeffArray[ b ][ d ] −= disp
        }
    }
  }
  for ( v = vcount0; v < vcount1; ++v) {
    a = verCoordEdges[ v ][ 0 ]
    b = verCoordEdges[ v ][ 1 ]
    for ( d = 0; d < DisplacementDim; d++) {
      dispCoeffArray[ v ][ d ] +=
      predWeights * (dispCoeffArray[ a ][ d ] +
      dispCoeffArray[ b ][ d ])
    }
  }
}
for ( v = 0; v < verCoordCount; ++v) {
  for ( d = 0; d < DisplacementDim; d++ ) {
    dispArray[ v ][ d ] = dispCoeffArray[ v ][ d ]
  }
}
```

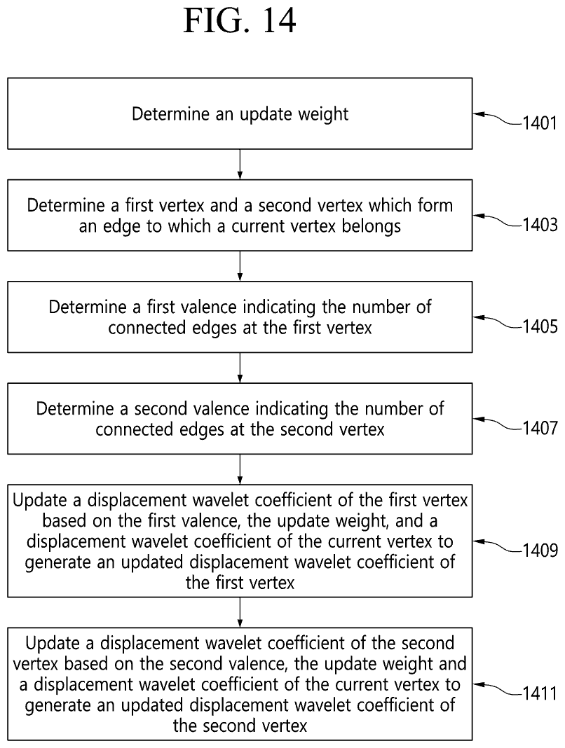

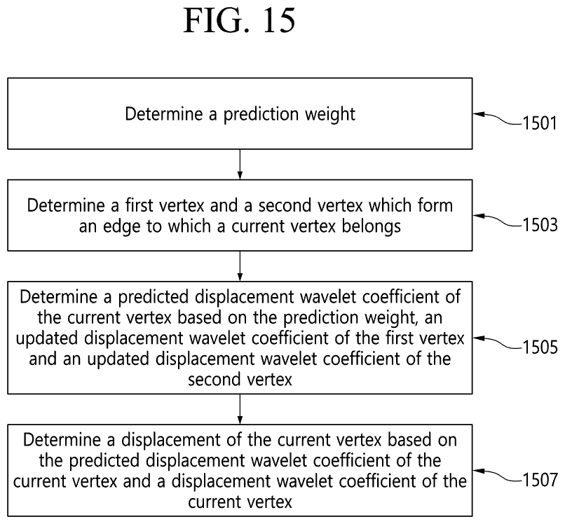

In Table 5, the inverse wavelet transform is shown where an array of displacements is generated by implementation of the update process illustrated in FIG. 14 and the prediction process illustrated in FIG. 15.

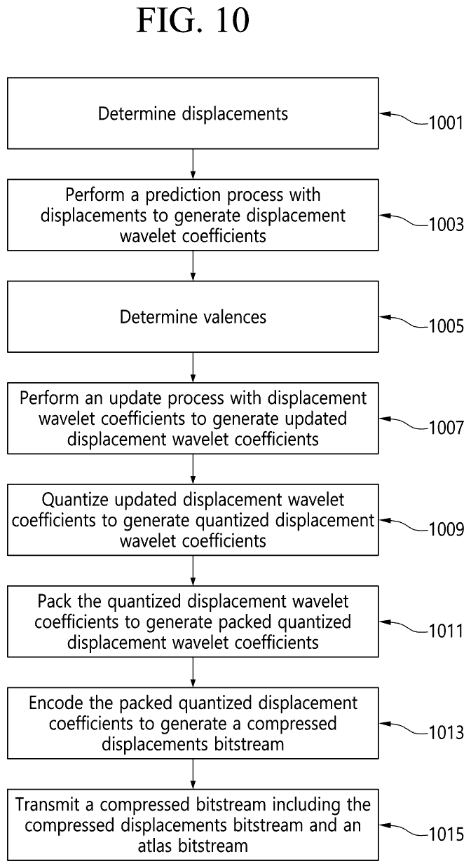

FIG. 10 is a flowchart showing operations of the V-DMC encoder 400 in accordance with an embodiment.

Referring to FIG. 10, the V-DMC encoder 400 encodes an original mesh frame.

At 1001, the V-DMC encoder 400 determines an array dispArray of displacements.

At 1003, the wavelet transformer 409 of the V-DMC encoder 400 performs a prediction process with the array dispArray of displacements to generate an array dispCoeffArray of displacement wavelet coefficients.

At 1005, the V-DMC encoder 400 determines an array of valences, each of which indicates the number of connected edges at a respective one vertex in a base mesh.

At 1007, the wavelet transformer 409 of the V-DMC encoder 400 performs an update process with the array dispCoeffArray of displacement wavelet coefficients to generate the array dispCoeffArray of updated displacement wavelet coefficients.

At 1009, the quantizer 411 of the V-DMC encoder 400 quantizes the array dispCoeffArray of updated displacement wavelet coefficients to generate an array dispQuantCoeffArray of the quantized displacement wavelet coefficients.

At 1011, the image packer 413 of the V-DMC encoder 400 packs the array dispQuantCoeffArray of the quantized displacement wavelet coefficients into a 2D image dispQuantCoeffFrame including packed quantized displacement wavelet coefficients.

At 1013, the video encoder 415 of the V-DMC encoder 400 encodes the packed quantized displacement wavelet coefficients dispQuantCoeffFrame to generate a compressed displacements bitstream.

At 1015, the V-DMC encoder 400 transmits a compressed bitstream including the compressed displacements bitstream and an atlas bitstream. In some embodiments, the atlas bitstream may include a first syntax element for determining the prediction weight and a second syntax element for determining the update weight.

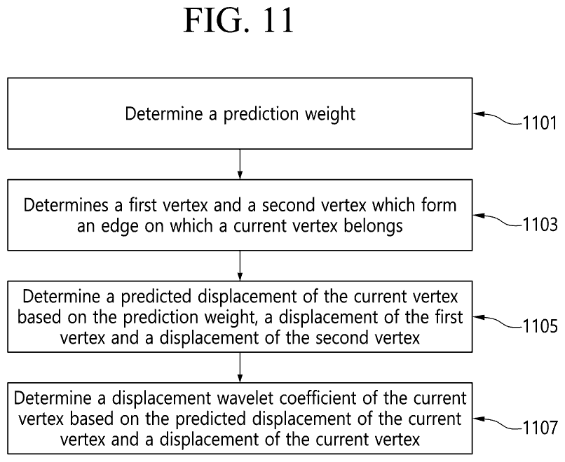

FIG. 11 is a flowchart showing prediction process operations of the wavelet transformer 409 of the V-DMC encoder 400 in accordance with an embodiment.

Referring to FIG. 11, the wavelet transformer 409 determines a displacement wavelet coefficient.

At 1101, the wavelet transformer 409 determines a prediction weight.

At 1103, the wavelet transformer 409 determines a first vertex v₁ and a second vertex v₂ which form an edge to which a v-th vertex belongs.

At 1105, the wavelet transformer 409 determines a predicted displacement of the v-th vertex based on the prediction weight, a displacement of the first vertex v₁ in the array dispArray, and a displacement of the second vertex v₂ in the array dispArray.

At 1107, the wavelet transformer 409 determines a displacement wavelet coefficient of the v-th vertex based on the predicted displacement of the v-th vertex and a displacement of the v-th vertex in the array dispArray to store displacement wavelet coefficient of the v-th vertex in the array dispCoeffArray of displacement wavelet coefficients.

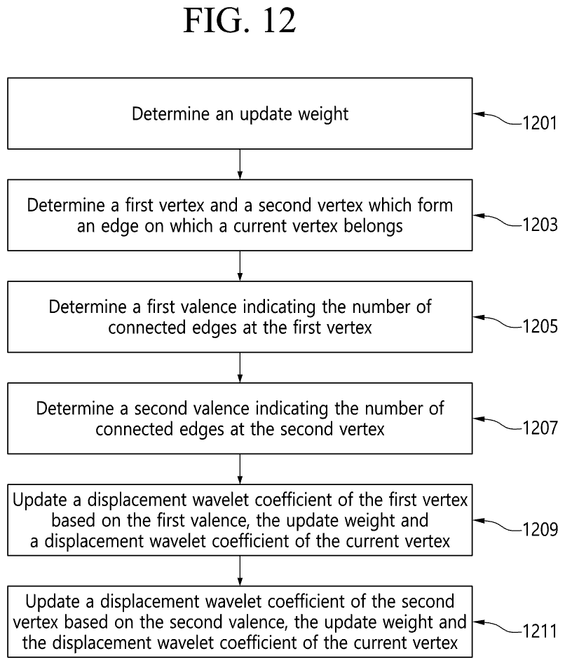

FIG. 12 is a flowchart showing update process operations of the wavelet transformer 409 of the V-DMC encoder 400 in accordance with an embodiment.

Referring to FIG. 12, the wavelet transformer 409 determines an updated displacement wavelet coefficient.

At 1201, the wavelet transformer 409 determines an update weight.

At 1203, the wavelet transformer 409 determines a first vertex v₁ and a second vertex v₂ which form an edge to which a v-th vertex belongs.

At 1205, the wavelet transformer 409 determines a first valence indicating the number of connected edges at the first vertex v₁. In some embodiments, if the first vertex v₁ belongs to the base mesh, the inverse wavelet transformer 527 may determine the first valence based on an index of the first vertex v₁ from an array of predetermined valences. The array of the predetermined valences requires a memory and much prior computation. In some embodiments, if the first vertex v₁ does not belong to the base mesh, the inverse wavelet transformer 527 may determine that the first valence is equal to a predetermined value. In some embodiments, the predetermined value may be equal to 6. In some embodiments, the predetermined value may be equal to 4 where the first vertex v₁ belongs to an edge which belongs to the boundary of the reconstructed base mesh. In some embodiments, the predetermined value may be equal to a value fixed for all levels of detail. In some embodiments, the predetermined value may be equal to a value fixed per level of detail. The computational and memory requirements can be substantially reduced because the memory and the prior computation are not required when the first vertex v₁ does not belong to the base mesh.

At 1207, the wavelet transformer 409 determines a second valence indicating the number of connected edges at the second vertex v₂. In some embodiments, if the second vertex v₂ belongs to the base mesh, the inverse wavelet transformer 527 may determine the second valence based on an index of the second vertex v₂ from an array of predetermined valences. The array of the predetermined valences requires a memory and much prior computation. In some embodiments, if the second vertex v₂ does not belong to the base mesh, the inverse wavelet transformer 527 may determine that the second valence is equal to a predetermined value. In some embodiments, the predetermined value may be equal to 6. In some embodiments, the predetermined value may be equal to 4 where the second vertex v₂ belongs to an edge which belongs to the boundary of the reconstructed base mesh. In some embodiments, the predetermined value may be equal to a value fixed for all levels of detail. In some embodiments, the predetermined value may be equal to a value fixed per level of detail. The computational and memory requirements can be substantially reduced because the memory and the prior computation are not required when the second vertex v₂ does not belong to the base mesh.

At 1209, the wavelet transformer 409 updates a displacement wavelet coefficient of the first vertex v₁ in the array dispCoeffArray based on the first valence, the update weight, and a displacement wavelet coefficient of the v-th vertex in the array dispCoeffArray to generate an updated displacement wavelet coefficient of the first vertex v₁ to store the updated displacement wavelet coefficient of the first vertex v₁ in the array dispCoeffArray.

At 1211, the wavelet transformer 409 updates a displacement wavelet coefficient of the second vertex v₂ in the array dispCoeffArray based on the second valence, the update weight, and the displacement wavelet coefficient of the v-th vertex in the array dispCoeffArray to generate an updated displacement wavelet coefficient of the second vertex v₂ to store the updated displacement wavelet coefficient of the first vertex v₂ in the array dispCoeffArray.

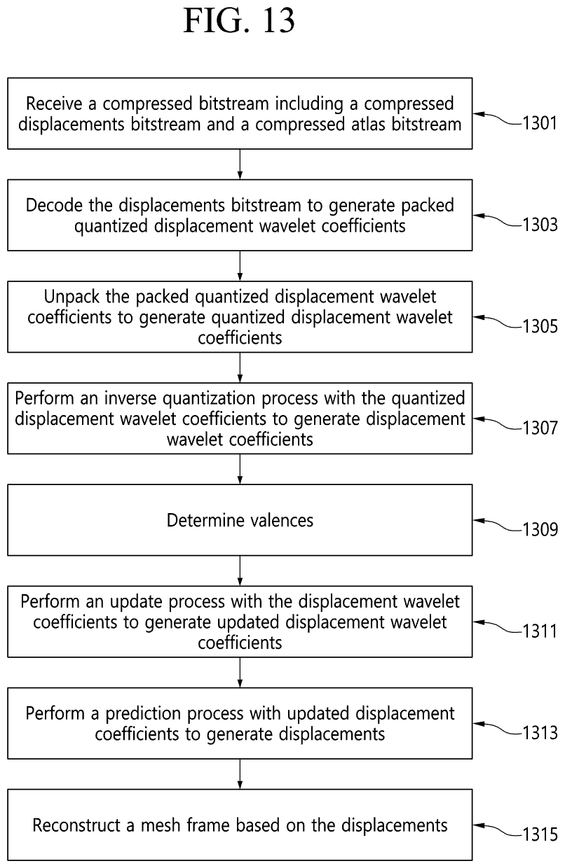

FIG. 13 is a flowchart showing operations of the V-DMC decoder 500 in accordance with an embodiment.

Referring to FIG. 13, the V-DMC decoder 500 decodes a V3C bitstream to generate a deformed mesh.

At 1301, the V-DMC decoder 500 receives a compressed bitstream including a compressed displacements bitstream and an atlas bitstream. In some embodiments, the atlas bitstream may include a first syntax element for determining an update weight and a second syntax element for determining a prediction weight.

At 1303, the video decoder 521 of the V-DMC decoder 500 decodes the displacements bitstream to generate an array dispQuantCoeffFrame of packed quantized displacement wavelet coefficients.

At 1305, the image unpacker 523 of the V-DMC decoder 500 unpacks the array dispQuantCoeffFrame of the packed quantized displacement wavelet coefficients to generate an array dispQuantCoeffArray of quantized displacement wavelet coefficients.

At 1307, the inverse quantizer 525 of the V-DMC decoder 500 performs an inverse quantization process with the array dispQuantCoeffArray of quantized displacement wavelet coefficients to generate an array dispCoeffArray of displacement wavelet coefficients.

At 1309, the V-DMC decoder 500 determines an array of valences, each of which indicates the number of connected edges at a respective one vertex in a base mesh.

At 1311, the inverse wavelet transformer 527 of the V-DMC decoder 500 performs an update process with the array dispCoeffArray of displacement wavelet coefficients to generate the array dispCoeffArray of updated displacement wavelet coefficients.

At 1313, the inverse wavelet transformer 527 of the V-DMC decoder 500 performs a prediction process with the array dispCoeffArray of updated displacement wavelet coefficients to generate an array dispArray of displacements.

At 1315, the deformed mesh reconstructor 529 of the V-DMC decoder 500 reconstructs a mesh frame recMeshFrame based on the array dispArray of displacements.

FIG. 14 is a flowchart showing update process operations of the inverse wavelet transformer 527 of the V-DMC decoder 500 in accordance with an embodiment.

Referring to FIG. 14, the inverse wavelet transformer 527 determines an updated displacement wavelet coefficient.

At 1401, the inverse wavelet transformer 527 determines an update weight based on the first syntax element.

At 1403, the inverse wavelet transformer 527 determines a first vertex v₁ and a second vertex v₂ which form an edge to which a v-th vertex belongs.

At 1405, the inverse wavelet transformer 527 determines a first valence indicating the number of connected edges at the first vertex v₁. In some embodiments, if the first vertex v₁ belongs to the base mesh, the inverse wavelet transformer 527 may determine the first valence based on an index of the first vertex v₁ from the array of predetermined valences. The array of the predetermined valences requires a memory and much prior computation. In some embodiments, if the first vertex v₁ does not belong to the base mesh, the inverse wavelet transformer 527 may determine that the first valence is equal to a predetermined value. In some embodiments, the predetermined value may be equal to 6. In some embodiments, if the first vertex v₁ belongs to an edge which belongs to the boundary of the reconstructed base mesh, the predetermined value may be equal to 4. In some embodiments, the predetermined value may be equal to a value fixed for all levels of detail. In some embodiments, the predetermined value may be equal to a value fixed per level of detail. The computational and memory requirements can be substantially reduced because the memory and the prior computation are not required when the first vertex v₁ does not belong to the base mesh.

At 1407, the inverse wavelet transformer 527 determines a second valence indicating the number of connected edges at the second vertex v₂. In some embodiments, if the second vertex v₂ belongs to the base mesh, the inverse wavelet transformer 527 may determine the second valence based on an index of the second vertex v₂ from the array of predetermined valences. The array of predetermined valences requires a memory and much prior computation. In some embodiments, if the second vertex v₂ does not belong to the base mesh, the inverse wavelet transformer 527 may determine that the first valence is equal to a predetermined value. In some embodiments, the predetermined value may be equal to 6. In some embodiments, the predetermined value may be equal to 4 where the second vertex v₂ belongs to an edge which belongs to the boundary of the reconstructed base mesh. In some embodiments, the predetermined value may be equal to a value fixed for all levels of detail. In some embodiments, the predetermined value may be equal to a value fixed per level of detail. The computational and memory requirements can be substantially reduced because the memory and the prior computation are not required when the second vertex v₂ does not belong to the base mesh.

At 1409, the inverse wavelet transformer 527 updates a displacement wavelet coefficient of the first vertex v₁ based on the first valence, the update weight, and a displacement wavelet coefficient of the v-th vertex in the array dispCoeffArray to generate an updated displacement wavelet coefficient of the first vertex v₁ and store updated displacement wavelet coefficient of the first vertex v₁ in the array dispCoeffArray.

At 1411, the inverse wavelet transformer 527 updates a displacement wavelet coefficient of the second vertex v₂ based on the second valence, the update weight, and a displacement wavelet coefficient of the v-th vertex in the array dispCoeffArray to generate an updated displacement wavelet coefficient of the second vertex v₂ and store updated displacement wavelet coefficient of the second vertex v₂ in the array dispCoeffArray.

FIG. 15 is a flowchart showing prediction process operations of the inverse wavelet transformer 527 of the V-DMC decoder 500 in accordance with an embodiment.

Referring to FIG. 15, the inverse wavelet transformer 527 determines displacements.

At 1501, the inverse wavelet transformer 527 determines a prediction weight based on the second syntax element.

At 1503, the inverse wavelet transformer 527 determines a first vertex v₁ and a second vertex v₂ which form an edge to which a v-th vertex belongs.

At 1505, the inverse wavelet transformer 527 determines a predicted displacement wavelet coefficient of the v-th vertex based on the prediction weight, the updated displacement wavelet coefficient of the first vertex v₁ the array dispCoeffArray of updated displacement wavelet coefficients, and the updated displacement wavelet coefficient of the second vertex v₂ in the array dispCoeffArray of updated displacement wavelet coefficients.

At 1507, the inverse wavelet transformer 527 determines a displacement of the v-th vertex based on the predicted displacement wavelet coefficient of the v-th vertex and a displacement wavelet coefficient of the v-th vertex in the array dispCoeffArray of updated displacement wavelet coefficients to store the displacement of the v-th vertex in the array dispArray of displacements.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of processes, operations, or processes disclosed is an illustration of exemplary approaches. Unless explicitly stated otherwise, it is understood that the specific order or hierarchy of processes, operations, or processes may be performed in different order. Some of the processes, operations, or processes may be performed simultaneously or may be performed as a part of one or more other processes, operations, or processes. The accompanying method claims, if any, present elements of the various processes, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase process for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
a communication interface configured to receive a compressed bitstream including a base mesh sub-bitstream and a displacements sub-bitstream; and
a processor operably coupled to the communication interface; the processor configured to:
reconstruct a base mesh,
perform one or more subdivisions of the base mesh to generate a subdivided mesh including a plurality of vertices,
decode the displacements sub-bitstream to reconstruct displacement wavelet coefficients for the plurality of vertices,
perform an update process with the displacement wavelet coefficients to generate updated displacement wavelet coefficients for the plurality of vertices,
wherein during the update process, the processor is configured to:
determine a first valence indicating a number of connected edges at a first vertex which forms an edge to which a current vertex belongs, based on whether the first vertex belongs to the base mesh, and
update a displacement wavelet coefficient of the first vertex based on the first valence,
perform a prediction process with the updated displacement wavelet coefficients to generate reconstructed displacements, and
reconstruct a mesh frame based on the reconstructed displacements and the subdivided mesh.

2. The apparatus of claim 1, wherein the first valence is determined to be equal to a predetermined value if the vertex does not belong to the base mesh.

3. The apparatus of claim 2, wherein the first valence is determined based on an index of the first vertex from an array of predetermined valences if the first vertex belongs to the base mesh.

4. The apparatus of claim 2, wherein the predetermined value is 6.

5. The apparatus of claim 1, wherein during the update process, the processor is further configured to:
determine a second valence indicating a number of connected edges at a second vertex which forms the edge to which the current vertex belongs, based on whether the second vertex belongs to the base mesh, and
update a displacement wavelet coefficient of the second vertex based on the second valence.

6. The apparatus of claim 1, wherein an update weight is determined based on the first syntax element, and
the displacement wavelet coefficient of the first vertex is updated based on the first valence and the update weight.

7. The apparatus of claim 1, wherein:
the compressed bitstream further includes an atlas sub-bitstream including a first syntax element for determining an update weight,
an update weight is determined based on the first syntax element in the bitstream, and
the displacement wavelet coefficient of the first vertex is updated based on the first valence and the update weight.

8. The apparatus of claim 1, wherein:
the compressed bitstream further includes an atlas sub-bitstream including a second syntax element for determining a prediction weight,
a prediction weight is determined based on the second syntax element in the bitstream, and
the displacement of the current vertex is determined based on the prediction weight and the updated displacement wavelet coefficient of the first vertex.

9. A method comprising:
receiving a compressed bitstream including a base mesh sub-bitstream and a displacements sub-bitstream,
reconstructing a base mesh,
performing one or more subdivisions of the base mesh to generate a subdivided mesh including a plurality of vertices,
decoding the displacements sub-bitstream to reconstruct displacement wavelet coefficients for the plurality of vertices,
performing an update process with the displacement wavelet coefficients to generate updated displacement wavelet coefficients for the plurality of vertices,
wherein determining a first valence indicating a number of connected edges at a first vertex which forms an edge to which a current vertex belongs, based on whether the first vertex belongs to the base mesh, and
wherein updating a displacement wavelet coefficient of the first vertex based on the first valence,
performing a prediction process with the updated displacement wavelet coefficients to generate reconstructed displacements, and
reconstructing a mesh frame based on the reconstructed displacements and the subdivided mesh.

10. The method of claim 9, wherein the first valence is determined to be equal to a predetermined value if the vertex does not belong to the base mesh.

11. The method of claim 10, wherein the first valence is determined based on an index of the first vertex from an array of predetermined valences if the first vertex belongs to the base mesh.

12. The method of claim 10, wherein the predetermined value is 6.

13. The method of claim 9, wherein, during the update process, the processor is further configured to:
determine a second valence indicating a number of connected edges at a second vertex which forms the edge to which the current vertex belongs, based on whether the second vertex belongs to the base mesh, and
update a displacement wavelet coefficient of the second vertex based on the second valence.

14. The method of claim 9, wherein:
the compressed bitstream includes an atlas sub-bitstream including a first syntax element for determining an update weight,
an update weight is determined based on the first syntax element in the bitstream, and the displacement wavelet coefficient of the first vertex is updated based on the first valence and the update weight.

15. The method of claim 9, wherein:
the compressed bitstream further includes an atlas sub-bitstream including a second syntax element for determining a prediction weight,
the prediction weight is determined based on the second syntax element in the bitstream, and
the displacement of the current vertex is determined based on the prediction weight and the updated displacement wavelet coefficient of the first vertex.

16. An apparatus comprising:
a communication interface; and
a processor operably coupled to the communication interface; the processor configured to:
reconstruct a base mesh,
perform one or more subdivisions of the base mesh to generate a subdivided mesh including a plurality of vertices,
determine displacements,
perform a prediction process with the displacements to generate displacement wavelet coefficients,
perform an update process with the displacement wavelet coefficients to generate updated displacement wavelet coefficients,
wherein during the update process, the processor is configured to:
determine a first valence indicating a number of connected edges at a first vertex which forms an edge to which a current vertex belongs, based on whether the first vertex belongs to the base mesh, and
update a displacement wavelet coefficient of the first vertex based on the first valence,
encode the updated displacement wavelet coefficients to generate a compressed displacements bitstream, and
transmit a compressed bitstream including the compressed displacements bitstream.

17. The apparatus of claim 16, wherein the first valence is determined to be equal to a predetermined value if the vertex does not belong to the base mesh.

18. The apparatus of claim 17, wherein the first valence is determined based on an index of the first vertex from an array of predetermined valences if the first vertex belongs to the base mesh.

19. The apparatus of claim 17, wherein the predetermined value is 6.

20. The apparatus of claim 16, wherein during the update process, the processor is configured to:
determine a second valence indicating a number of connected edges at a second vertex which forms the edge to which the current vertex belongs, based on whether the second vertex belongs to the base mesh, and
update a displacement wavelet coefficient of the second vertex based on the second valence.
